(19) United States
(12) Patent Application Publication
(10) Pub. No.: US 2026/0216624 A1
(43) Pub. Date: Jul. 30, 2026

(54) FILTER SCREEN, TUBULAR FILTER AND FILTER DEVICE

(71) Applicant: Maag Ettlinger GmbH, Königsbrunn (DE)

(72) Inventors: Thorsten ETTLINGER, Schwabmünchen (DE); Rainer SIMMERLEIN, Königsbrunn (DE)

(21) Appl. No.: 19/454,526

(22) Filed: Jan. 21, 2026

(30) Foreign Application Priority Data
Jan. 30, 2025 (DE) 20 2025 100 476.3

(51) Int. Cl. B01D 33/46; B01D 29/15; B01D 29/23; B01D 29/64; B01D 33/073; B01D 33/11; B01D 39/10

(52) U.S. Cl. CPC B01D 33/466; B01D 29/15; B01D 29/23; B01D 29/6469; B01D 33/073; B01D 33/11; B01D 39/10

(57) ABSTRACT

A filter screen (4) for a tubular filter (2) for filtering liquids including polymer melts (24). The screen is bent from a flat screen blank (19) as a screen wall (11) with a filter axis (3). A circumference of the screen wall has a perforation region (13) with through openings (14). A connecting configuration (17), particularly a weld seam, is aligned with an axial direction component. The perforation region has region edges (15), at circumferential ends, extending with an axial direction component. The region edges end at a distance from the connecting configuration, forming a spacer region (18). At least one of the region edges, in an axial profile thereof, has a profile geometry (16) with varying edge distances (al,a2) from the adjacent connecting configuration. The profile geometry, in the circumferential direction, has a profile depth (t) which is a multiple of the diameters of the through openings.

### CROSS REFERENCE TO RELATED APPLICATIONS

This application claims the benefit of priority under 35 U.S.C. §119 of German Application 202025100 476.3, filed January 30, 2025, the entire contents of which are incorporated herein by reference.

### TECHNICAL FIELD

The invention relates to a filter screen, a tubular filter and a filter device configured for filtering liquids, wherein the tubular filter screen has a filter axis, a screen wall and, on a circumference of the screen wall, a perforation region with densely packed, fine through openings and a connecting means, which is aligned with an axial direction component.

### BACKGROUND

DE 102017212944 Al discloses a circular-cylindrical steam screen for quick-closing valves of a steam turbine, in which a plurality of perforated individual screen segments produced by selective laser melting are arranged loosely successively in the circumferential direction with an overlap and bolted to end-face support rings. The perforation region with through openings of the screen elements has a rectilinear, axially extending region edge in the circumferential direction.

KR 102564335 B1, KR 100992097 B1 and KR 100988217 B1 each relate to a tubular filter for a plate heat exchanger, wherein the perforated circular-cylindrical filter casing is fastened to an inner spiral filter carrier by welding or its circumferential edges overlap and are fastened by inner tabs or the circumferential edges are spaced apart and movably connected by an elastic connecting means inserted in the gap. The perforation regions with through openings have a rectilinear, axially extending region edge in the circumferential direction.

WO 97/26973 Al discloses a filter device, a tubular filter element and a filter screen and also a stripper which is arranged on the filter screen for stripping the filter residues from the filter screen. The filter screen is bent in round form from a flat screen blank or screen sheet and has a screen wall with a perforation region of densely packed, fine through openings in the form of laser holes. The screen sheet or the screen wall is joined together to form a hollow cylinder with a circular cross section, a so-called hollow circular cylinder, this taking place in practice by means of an axial weld seam. The perforation region extends in the circumferential direction on both sides as far as the weld seam. The filter screen and its screen wall have a mechanical point of weakness in the region of the weld seam and the adjoining perforation region.

### SUMMARY

It is an object of the invention to disclose filter screen technology which is improved in terms of the mechanical stability.

The invention achieves this object with features according to this disclosure.

The filter screen technology, i.e. the filter screen, the screen blank, the tubular filter, the filter device, the method for producing a filter screen and the use of the filter screen, the tubular filter and the filter device for producing a filtered liquid, in particular a polymer melt, have various advantages. The stability, mechanical stability and efficiency of the filter screen, of the tubular filter equipped therewith and of the filter device are improved. This means that a high and consistent quality of the filtration and of the filtered liquid, in particular a polymer melt, can also be achieved and wear during the filtration can be avoided or at least reduced.

The filter screen having filter screen features disclosed herein has the advantage that the end-side region edges of the perforation region extending with an axial direction component and positioned in the circumferential direction end, as seen in the circumferential direction, at the connecting point at a distance in front of the connecting means. The perforation region and the tightly packed, fine through openings there are thus spaced in the circumferential direction from the connecting means, e.g. a weld seam. The spacer region may be formed differently from the perforation region. For example, it may be solid. In addition, at least one region edge in its axial course may have a profile geometry with varying edge distances from the adjacent connecting means. The profiled region edge, due to its varying edge distances in its profile, also has a further direction component, which points transversely to the axial direction, in particular in the circumferential direction.

The spacer region and the profile geometry have a favourable effect on the high mechanical load-bearing capacity and stability of the filter screen. During operation, the bent screen wall of the filter screen is dimensionally stable and dimensionally accurate throughout the entire circumference, including the region of the connecting means. This is also favourable for an efficient and low-stress detaching, in particular stripping, of the filter residues. The connecting means and the bent screen wall can merge flush and smoothly into each other, at least on the screen wall side approached by the flow of liquid, in particular polymer melt. As a result, they do not obstruct the detaching, in particular stripping, of the filter residues and have a wear-reducing effect. The high dimensional accuracy has a favourable effect on the uniform and long-term, high filtration quality. This is particularly advantageous for liquid, in particular optionally also viscous, liquids, in particular polymer melts.

The filter screen with features as disclosed herein can be produced by a method disclosed herein. The filter screen may be a stand-alone product. It may be present on a tubular filter and a filter device in the initial equipment. It may also be retrofitted or refitted on a tubular filter and a filter device, in particular in exchange for another existing filter screen.

The filter screen, the tubular filter and the filter device are configured for filtering liquids, in particular polymer melts. The filter screen, but also the tubular filter and the filter device, can be used for producing filtered liquids, in particular polymer melts.

The perforation region and its densely packed, fine through openings can be correspondingly adapted in their size, configuration and arrangement to the possibly different properties of the liquids to be filtered, in particular polymer melts.

The filter screen is preferably bent from a flat screen blank, in particular in round form, preferably in circular form. The edges thereof, which are positioned in the circumferential direction and aligned with an axial direction component, butt together at a connecting point or a so-called joining point, preferably in a butt joint, and can be fixedly connected to each other by the connecting means. Instead of a weld seam, another material connecting means aligned with an axial direction component, e.g. an adhesive seam, is also possible.

The axial alignment specified in the claims and in the description below refers to the filter axis of the bent filter screen or of the tubular filter. This may be, for example, the central axis of a preferably hollow, circular-cylindrical filter screen. The filter screen may also have a different tubular shape, e.g. may be in the form of a hollow truncated cone. The preferably circular cross-sectional shape may also vary. A hollow, circular-cylindrical shape is advantageous, for example, for a filter screen rotating about the filter axis. A stationary filter screen may also have a different, e.g. oval or prismatic, cross-sectional shape. The screen blank may accordingly be bent differently.

Said axial direction component of the connecting means and/or of the region edge and/or of the blank edges may comprise an exact axial alignment. There may also be another superimposed direction component, e.g. in the circumferential direction. This can result, for example, in an oblique or helical extent.

The profile geometry may have different configurations. For example, it may have at least one protrusion pointing towards the connecting means. Alternatively, or additionally, it may have at least one indentation pointing away from the connecting means. This protrusion and/or indentation may be present individually or in multiple form. In the region of a protrusion and/or indentation, the profiled region edge may have a further and other direction component superimposed on the axial direction component, in particular in the circumferential direction. In the region of a protrusion and/or indentation, the region edge may extend transversely or obliquely to the filter axis. This increases the mechanical strength in this region.

In an advantageous refinement, a plurality of protrusions and a plurality of indentations are present, for example, following one another in a direct sequence or alternating in another way. There may be a cycle here. A protrusion may be followed directly by an indentation, etc. In a variation to this, in a different alternating sequence, for example, two or more protrusions may follow one another, with one or more indentations then adjoining them, etc.

The protrusion or protrusions and indentation or indentations may point towards the connecting device or may point away from the connecting device in the circumferential direction of the filter screen.

In an advantageous refinement, a plurality of said through openings may be arranged successively and next to one another in the circumferential direction in a protrusion of the region edge pointing towards the connecting means. Said through openings may be absent in the region of an indentation pointing away from the connecting means. Here, the screen wall may be solid, for example. The spacer region may extend into an indentation.

An advantageous refinement makes provision that the profile geometry, as seen in the circumferential direction, has a profile depth (t) which is a multiple of the diameters of the through openings. The profile depth (t) may refer to the direction extending transversely to the axial course of the region edge, in particular the circumferential direction. The profile depth (t) may, for example, relate to the distance in the circumferential direction between the zeniths of the protrusion or protrusions and indentation or indentations. This may also be understood as meaning the amplitude of lateral deviations of the profiled region edge from the axial extent.

The profiled region edge of the perforation region can thus have significant changes, in particular transversely or obliquely directed deviations, from its axial extent.

A significant profile geometry has been shown to be particularly advantageous for the stability of the filter screen.

The profile geometry mentioned may be present at only one or at both perforation region edges positioned in the circumferential direction. The perforation region itself may be present continuously between said region edges. Alternatively, it may also have one or more interruptions, which may be formed, for example, by substantially solid regions of the screen wall. The perforation region may extend in the axial direction as far as the bent screen edge of the filter screen or may end on one or both sides at a distance in front thereof. In the spacer region, the screen wall may again be solid.

There are various options for the configuration of the profile geometry. The profile geometry may have, for example, a waveform with a plurality of protrusions pointing towards the adjacent connecting means and a plurality of indentations pointing away from the connecting means. The waveform may meander.

For example, the waveform may be uniform. This may refer to identical shapes and/or identical sizes of protrusions and indentations. In addition, there may be a cycle in the alternating arrangement of protrusions and indentations. Alternatively, a non-uniform waveform is possible, in which, for example, the protrusions and the indentations may differ in size and possibly differ in shape.

The profile geometry may comprise rounded or angular protrusions and/or indentations. A mixture of rounded and angular shapes is also possible. An angular design may be configured, for example, to be pointed in the manner of an arrow, or triangular or crenelated in rectangular form. In particular, it is also possible that the profile geometry of a region edge has only one individual and preferably rounded protrusion or only one individual, preferably rounded, indentation. Such an individual protrusion or indentation may extend over the entire length of the relevant region edge.

It is also possible that the profile geometry of a region edge in its profile also comprises one or more axial and rectilinear portions. A protrusion and an adjacent indentation may merge directly into each other. They may also be axially spaced apart from each other and connected, for example, by a rectilinear and axial profile portion of the profile geometry. Another possible configuration of the waveform may comprise only protrusions or only indentations, between which an axial and rectilinear portion is arranged.

Furthermore, it is possible that protrusions and indentations alternate with each other in any way, in particular with the insertion of a possibly rectilinear and axial profile portion of the profile geometry. In summary, a multiplicity of different configurations of the profile geometry are possible. In addition to the above examples, other variants are possible.

The spacer region between the at least one region edge and the connecting means may be solid. The solid configuration may also include smaller openings and/or groove-like recesses on the screen wall in the spacer region.

In an advantageous refinement, the screen wall may have a thickness of between 1.0 mm and 2.0 mm.

The through openings in the perforation region and in the screen wall may each have a diameter of between 30 pm and 1500 pm. A diameter of between 60 pm and 1000 pm is preferred.

The through openings may have any cross-sectional shape, e.g. circular or prismatic. The through openings may be identical to one another or differ from one another.

The through openings may be arranged in any way in the perforation region. They may be separated from one another by screen wall bars. The through openings may be arranged, for example, in a multiplicity of rows and columns, e.g. in a regular, preferably rectangular matrix. Adjacent rows or columns of through openings may also be positioned with a gap. The packing density of the through openings may be identical overall in the perforation region. Furthermore, irregular distributions and even different packing densities of through openings, which vary or vary locally, are possible.

The through openings pass through the screen wall. Their shape and orientation may differ. For example, they may have a cross-sectional shape that is the same over the length or may have a conical shape. The through openings may be oriented orthogonally to the screen wall surface. They may be aligned radially with respect to the filter axis in the case of the bent, in particular hollow, circular-cylindrical, filter screen. In a modification, one or more through openings may also have an oblique orientation.

In an advantageous refinement, the connecting point and the connecting means may have a rectilinear and axially aligned line shape. It is possible for a deviation from the exact axial alignment to be made. The connecting point and the connecting means may have a further direction component, e.g. pointing in the circumferential direction. The connecting point and the connecting means may thus have a helical profile, for example. The connecting means may have a continuous line shape. It may also have an interrupted line shape. Otherwise, other configurations of the connecting point and of the connecting means are possible. Instead of a weld seam, there may be another material connecting means, e.g. an adhesive seam or something else.

The screen wall may be formed from a flat, flexurally elastic metal sheet. The screen wall or the metal sheet may have said flat shape. The wide sides may be oriented parallel to each other. The material of the metal sheet can be selected. It can be adapted to the requirements of the fluid to be filtered. The metal sheet may be made, for example, of steel, in particular stainless steel, of brass or the like.

The through openings in the screen wall may be formed by means of radiation technology. Otherwise, other techniques for introducing the through openings are possible, e.g. material-removing drilling, punching, etching or the like.

In an advantageous refinement of the filter screen, blank edges of the bent screen blank may be butt-jointed at the connecting means in the circumferential direction. Said blank edges form the edges of the screen wall that are positioned in the circumferential direction. The connecting point and the connecting means may be situated here.

The invention also comprises a screen blank. The latter can be configured for forming the screen wall of a bent filter screen for a tubular filter. The screen blank may be flat and flexurally elastic and may have a perforation region mentioned with through openings and region edges. Said screen blank may be formed according to the above-mentioned refinement of the filter screen and its screen wall.

In the screen blank, the region edges of the perforation region may each end at a distance in front of an adjacent blank edge. Said blank edges are subsequently aligned with said axial direction component when the screen blank is bent to form the filter screen. In the screen blank, said blank edges may be formed, for example, by one transverse edge of an e.g. elongate screen blank. The other blank edges, which are aligned, for example, transversely to the region edge, may be the longitudinal edges of the screen blank. In the case of the bent screen filter, they may form the respective end-face, rounded screen edge.

The screen blank may be in the form of a preferably flat, rectangular, level and flexurally elastic metal sheet. This may be configured in the manner described above. The screen blank may otherwise have the refinements mentioned above for the screen wall, e.g. the stated thickness, the diameters of the through openings, etc.

The invention also comprises the stated tubular filter. The latter may also be a stand- alone product and may be used for the initial equipment, retrofitting or refitting of a filter device. The tubular filter is equipped with, for example, a hollow circular-cylindrical filter screen and its above-mentioned refinements. A tubular filter may also have a plurality of the filter screens mentioned. The tubular filter may also comprise a filter carrier on which the filter screen is arranged. This may preferably be a circumferential arrangement, in particular on the outside of the, for example, circular-cylindrical filter carrier. The filter carrier may in turn be permeable for the liquid to be filtered, in particular a polymer melt. The filter screen may be arranged on and fastened to the filter carrier so as to be exchangeable and detachable.

In an advantageous refinement, the filter carrier may be in the form of a rotatable filter shaft. The filter screen may be arranged on the rotatable filter shaft and may be rotated by the latter during operation of the filter. The filter carrier and the filter screen may be rotationally driven in a controlled way. They may have a coinciding, preferably central, filter axis.

The invention also comprises the filter device mentioned. The latter is equipped with a tubular, in particular hollow, circular-cylindrical filter screen, which may be formed in the manner described above. Likewise, the tubular filter may also be formed in the aforementioned manner.

The filter device may have a stripper for the filter residues. The stripper may be arranged on the outside or inside of the circumference of the tubular filter screen. For example, the stripper may be aligned, for example, with its line of action axially, in particular parallel, to the filter axis. Alternatively, it may also have an oblique, possibly also helical, alignment. The stripper may be arranged in stationary or movable and adjustable fashion. The filter device may furthermore have a discharge apparatus interacting with the stripper for the stripped filter residues. Said discharge apparatus may discharge the filter residues in intermittent and metered fashion.

The filter device may otherwise have a filter chamber with an inlet and an outlet for the liquid to be filtered, in particular a polymer melt. The filter screen may be arranged in the filter chamber in stationary or movable fashion, in particular so as to be rotationally driven, and connected to the inlet and the outlet. The liquid to be filtered, in particular a polymer melt, can flow through the filter screen from the outside to the inside, with the inner cavity of the filter screen and possibly of a filter carrier being connected to the outlet. The assignment may also be reversed.

The invention also comprises a method for producing the claimed filter screen. The invention also relates to the use of the claimed filter screen for producing a filtered liquid, in particular a polymer melt. Said use may also relate to the tubular filter and/or to the filter device.

Further advantageous refinements of the invention are specified in the dependent claims.

The described and claimed apparatus features of the filter screen, the tubular filter, the screen blank and the filter device may be advantageously used in the claimed method.

Conversely, the described and claimed method features may advantageously also be used in the claimed apparatus or apparatuses. The method and apparatus features are therefore interchangeable with one another.

The claimed apparatuses of filter screen, screen blank, tubular filter and filter device and the claimed methods may each comprise the following further features, which are usable individually or in any combination.

The perforation region may have a profile geometry with a preferably uniform, in particular meandering, waveform.

The perforation region may have a profile geometry with a protrusion or protrusions and/or an indentation or indentations, each of which may have a rounded and/or angular shape.

The spacer region between the region edge of the perforation region and the connecting means and also the connecting point may be solid.

The through openings of the perforation region may be formed by means of radiation technology.

The connecting means may have a rectilinear and axially aligned line shape. The connecting point may also have such a line shape.

The screen wall of the filter screen may be formed by the screen blank.

After the preferably round, in particular circular, bending, the screen blank may be provided at a connecting point with a connecting means, in particular a weld seam.

The edges of the screen blank, which is preferably bent in round form, in particular in circular form, that are positioned in the circumferential direction and aligned with an axial direction component, may be butt-jointed with each other at a preferably rectilinear connecting point and connected to a connecting means, in particular a weld seam.

The region edges of the perforation region may each end at a distance before an adjacent blank edge, in particular a transverse edge, of the screen blank.

The filter carrier of the tubular filter may be configured as a rotatable filter shaft.

The filter device may have a discharge apparatus interacting with a stripper for stripped filter residues.

The filter device may have a filter chamber with an inlet and an outlet for the liquid to be filtered, in particular a polymer melt. The filter screen may be arranged in the filter chamber in stationary or movable fashion, in particular so as to be rotationally driven, and connected to the inlet and the outlet.

In the production of a filtered liquid, in particular a polymer melt, using the claimed filter screen, a raw liquid containing particles which can be filtered out, in particular a polymer melt, can be supplied to the filter screen and, after passing through the filter screen, can be discharged as a filtered liquid, in particular a polymer melt, from the filter screen. The particles which are filtered out and deposited on the filter screen as filter residues may be detached, in particular stripped, from the filter screen and discharged.

The invention is illustrated by way of example and schematically in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a filter screen;

FIG. 2 is a detail view of the screen wall and of a screen blank at the connecting point with a connecting means and a perforation region with profiled circumferential region edges,

FIG. 3 is an enlarged detailed illustration of the profile geometry of the region edge at the connecting means;

FIGS. 4, 5, 6, 7 and 8 are views showing various variants in the configuration of the profile geometry of the region edge of the perforation region

FIG. 9 is a broken-off cross sectional view through the screen wall or the screen blank and various configuration variants of a through opening of the perforation region;

FIG. 10 is a top view showing a screen blank for forming the filter screen of FIG. 1;

FIG. l0a is a folded side view showing the screen blank of FIG. 10;

FIG. 11 is a screen in a sectioned side view showing a filter device with a tubular filter and the filter screen; and

FIG. 12 is a cross sectional view of the filter device according to the section line XII - XII of FIG. 11.

### DESCRIPTION OF PREFERRED EMBODIMENTS

Referring to the drawings, the invention relates to a filter screen (4), a screen blank (19), a tubular filter (2), a filter device (1) and to a method for producing a filter screen (4), and to the use of the filter screen (4) for producing filtered liquids, in particular polymer melts (24).

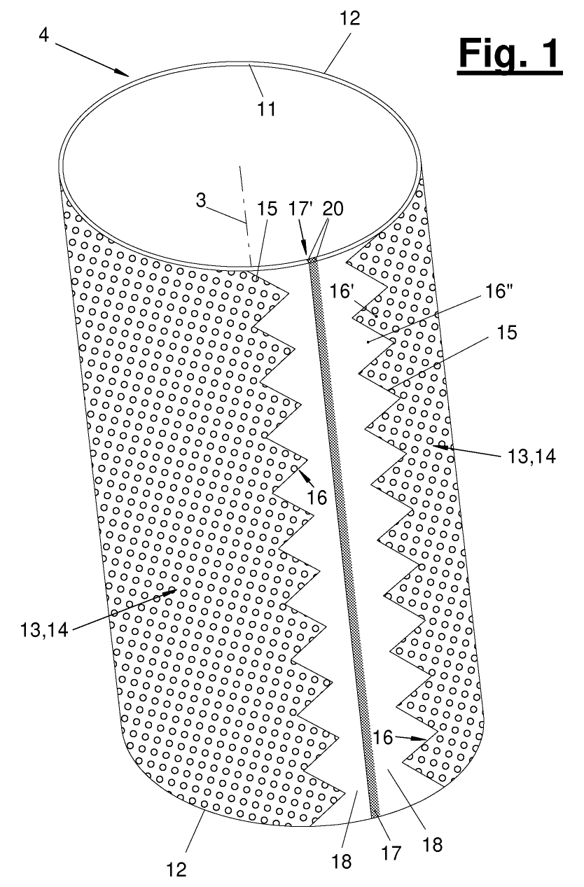

FIG. 1 shows the tubular, e.g. hollow, circular-cylindrical, filter screen (4) in a perspective illustration. The filter screen (4) is bent from a flat screen blank (19), preferably in round form, in particular circular form, and has a filter axis and a screen wall (11). On the circumference, the bent screen wall (11) has a perforation region (13) with densely packed, fine through openings (14).

A connecting means (17) aligned with an axial direction component is also arranged on this circumference. With said connecting means, the edges of the screen wall (11) butting together in the circumferential direction, in particular the blank edges (20) of the screen blank (19), are fixedly connected to each other. The connecting means (17) is configured, for example, as a weld seam. In the exemplary embodiments, it has a rectilinear alignment which is axial with respect to the filter axis (3). Alternatively, another, e.g. helical, extent of the preferably linear connecting means (17) is possible. In FIG. 1, the through openings (14) of the perforation region (13) are shown only on the outside of the screen wall (11) to provide an overview. They are also shown in schematized form and oversized so that they can be better seen.

According to FIG. 1, the perforation region (13) has, at each of its two ends in the circumferential direction, a region edge (15) which extends with an axial direction component. The region edges (15) each end at a distance in the circumferential direction in front of the connecting means (17). A spacer region (18) is formed here on the screen wall (11). The through holes (14) of the perforation region (13) are absent in the spacer region (18). The spacer region (18) is solid, for example. However, it may also have an isolated opening or groove-like recesses.

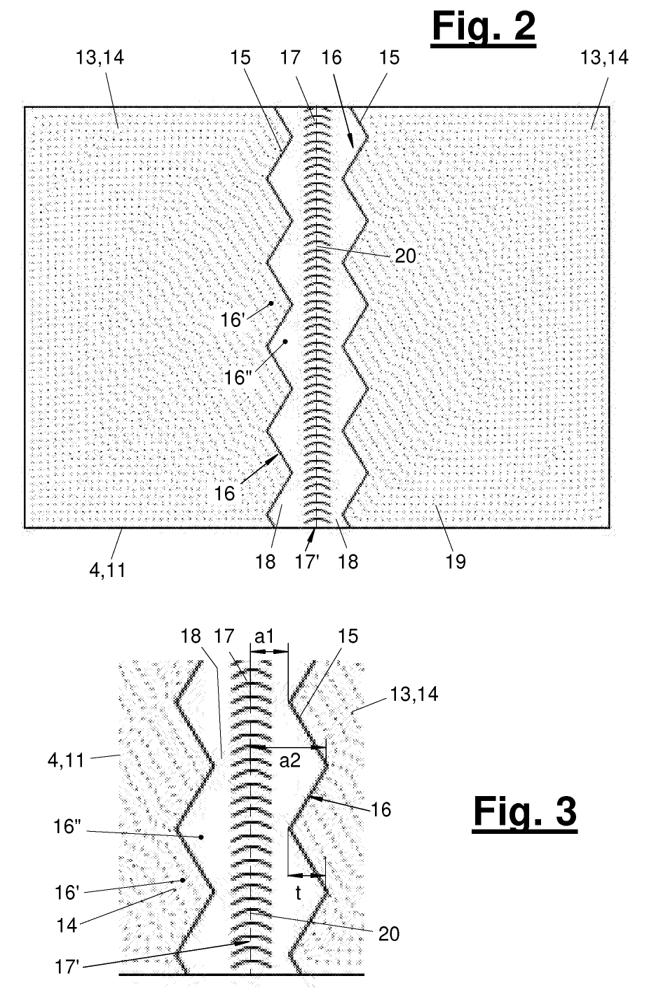

At least one region edge (15) has in its axial profile a profile geometry (16) with varying edge distances (al,a2) of the region edge (15) from the adjacent connecting means (17). FIG. 3 shows a detailed view of the edge distances (al,a2) facing in the circumferential direction.

The profile geometry (16) may be formed differently. FIGS. 2-8 show different variants in this respect. In FIGS. 2-8, the profile geometry (16) has a plurality of protrusions (16') pointing towards the connecting means (17) and a plurality of indentations (16") facing away from the connecting means (17). A plurality of through openings (14) are arranged in the protrusions (16') pointing in the circumferential direction towards the connecting means (17). In this case, according to FIGS. 1-8, a plurality of through openings (14) are arranged successively and next to one another in the circumferential direction.

As FIG. 3 illustrates, the profile geometry (16) has a profile depth (t) which is a multiple of the diameters of the through openings (14). The profile depth (t) is directed in the circumferential direction of the filter screen (4) and, in the exemplary embodiments shown, represents the distance between the zeniths of the protrusions (16') and the indentations (16"). The spacer region (18) extends into the indentations (16").

The profile geometry (16) has, for example, a waveform shown in FIGS. 1-8 with a plurality of protrusions (16') pointing in the circumferential direction towards the connecting means (17) and a plurality of indentations (16") pointing away from the connecting means (17). In this case, protrusions (16') and indentations (16") alternate with each other, e.g. in a direct sequence. The shaping and sizes of the protrusions (16') and indentations (16") are, for example, identical to one another. The exemplary embodiments reproduce a preferred uniform waveform of the profile geometry (16). Alternatively, the other and non-uniform embodiments of profile geometries (16) discussed above are possible.

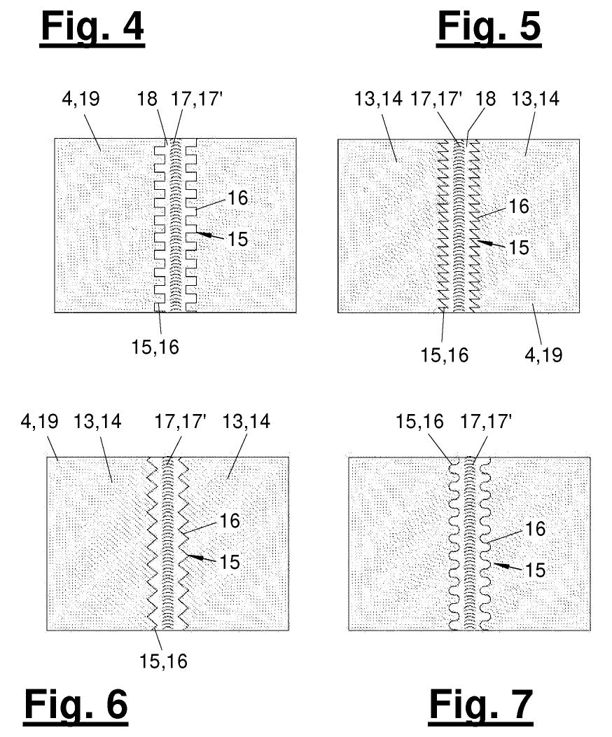

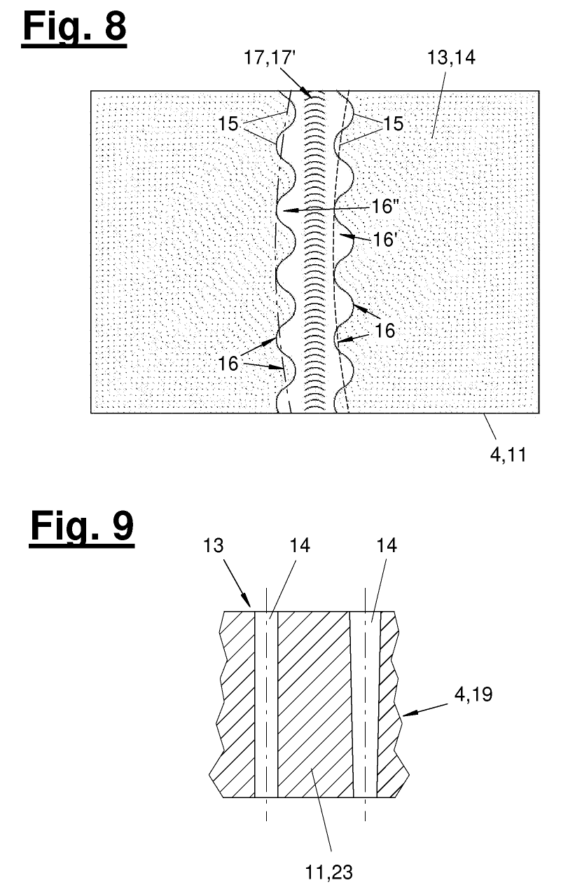

In the exemplary embodiments of FIGS. 1-6, the profile geometries (16) each have angular protrusions (16') and indentations (16"). These are configured in FIGS. 2, 5 and 6 as being pointed in the shape of arrows or triangular. FIG. 4 shows a crenellated profile geometry with rectangular protrusions (16') and indentations (16"). FIGS. 7 and 8 show variants with a rounded shaping of the protrusions (16') and indentations (16"). As the drawings illustrate, there may also be variations in the number and size of the protrusions (16') and indentations (16") arranged successively in a row.

FIG. 8 also illustrates a variant (broken lines) of the profile geometry (16) with only a preferably rounded protrusion (16') and/or only a preferably rounded indentation (16"). Here, for example, both region edges (15) can each have an individual protrusion (16') or can each have an individual indentation (16"). The above-mentioned variable edge distances (al,a2) and the profile depth (t) of the profile geometry (16) also arise, e.g. as an amplitude of the lateral deviations of the profiled region edge (15) of the individual protrusion (16') or indentation (16") from its axial extent.

FIG. 9 shows by way of example a detail from the screen wall (11) or the screen blank (19) with different configuration options for a through opening (14). The through openings (14) are aligned, for example, orthogonally to the outside of the screen wall (11) or the screen blank (19). In the case of the bent filter screen (4), they are, for example, aligned radially to the filter axis (3).

The through opening (14) shown in the left half of the image has a cross section that is constant over its length. The opening shape may be cylindrical. The other through hole (14) shown has, for example, a conical shape. The latter may, for example, taper towards the outside of the screen wall (11). For example, the outside may be the approach-flow side for the filtration.

The through openings (14) may have a circular cross-sectional shape, for example. The cross-sectional geometry may remain the same over the length of the through hole (14) or may vary. Alternatively, other cross-sectional shapes, e.g. oval, prismatic, etc. are possible.

The screen blank (19) and the screen wall formed therefrom (11) may advantageously have a thickness of between 1.0 mm and 2.0 mm.

For example, the through openings (14) may each have a diameter of between 30 µm and 1500 µm. A diameter of between 60 µm and 1000 µm is preferred.

The through openings (14) are formed in the screen blank (19) or in the screen wall (11) by means of radiation technology, e.g. by jet drilling.

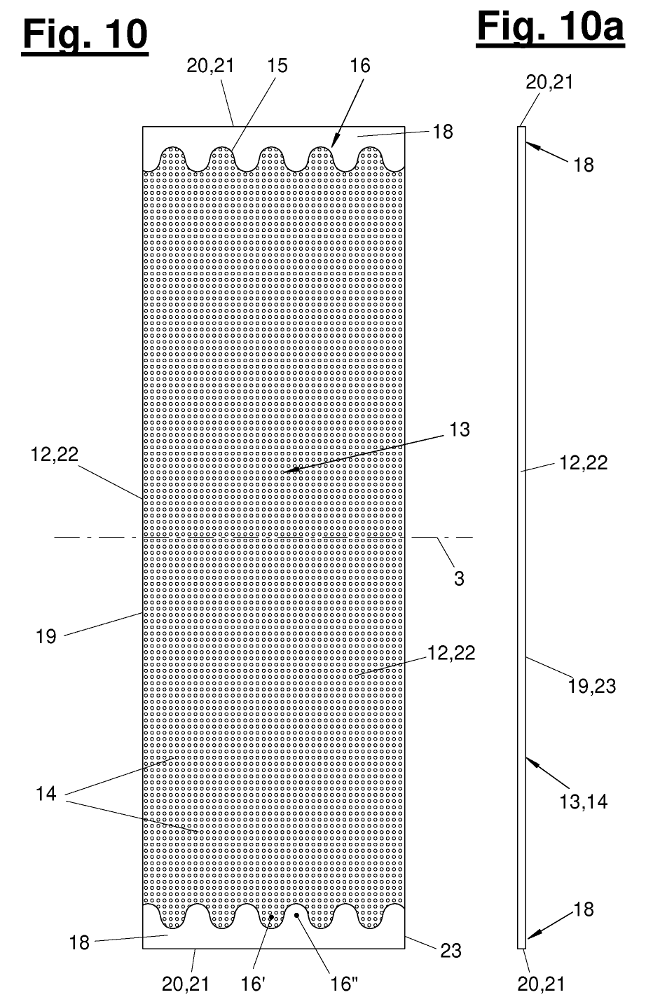

FIGS. 10 and 10a show, in top view and folded side view, a flat and level screen blank (19) with a preferably rectangular shape, from which then by preferably round, in particular circular, bending, the filter screen (4) shown in FIGS. 1, 11 and 12 and the preferably circular screen wall (11) thereof are formed. In this case, the preferably rectilinear blank edges (20) of the bent screen blank (19) are butt-jointed in the circumferential direction at the connecting point (17') or at the connecting means (17). FIGS. 1 and 2 show this butt joint, the connecting point (17') and the connecting means (17) attached there, in particular the weld seam. The blank edges (20) have, for example, a level shape and lie, for example, in a planar manner to each other by way of the preferably full-surface contact, with the connecting means (17), e.g. the weld seam, then being attached at the connecting point (17').

In the exemplary embodiments shown, the connecting means (17) has a rectilinear and axially aligned line shape. Alternatively, the connecting means (17) may also have a profile deviating from the axial alignment, e.g. a helical profile. The connecting point (17') may have a corresponding line shape and a corresponding profile.

Similarly, the one or both region edges (15) in the exemplary embodiments shown also have a substantially axial global alignment. The connecting lines between the zeniths of the protrusions (16') and also between the zeniths of the indentations (16") also have a rectilinear and axial alignment. In a variation thereto, it is also possible to deviate from the strictly axial alignment. Another and further direction component may be superimposed on the axial direction component, in particular in the circumferential direction. This may result, for example, in a helical profile of the region edges (15) and their profile geometry (16).

The screen blanks (19) and the screen wall (11) formed from the bent screen blank (19) are each formed from a flat, level and flexurally elastic metal sheet (23). The metal may be, for example, stainless steel or brass or another metal.

The screen blank (19) has, for example, the elongate and, in top view and side view, rectangular shape shown in FIGS. 10 and 10a. It has longitudinal edges (22) and shorter transverse edges (21). The screen blank (19) is bent, for example, to form the filter screen (4), e.g. over the longitudinal edges (22) and the filter and bending axis (3) indicated in FIG. 10. In the bent screen wall (11), the transverse edges (21) form, for example, the blank edges (20) which are positioned in the circumferential direction and butt-jointed at the connecting point (17'). The longitudinal edges (22) form the end-face screen edges (12) of the filter screen (4). In other embodiments, the screen blank (19) may have a different shape, e.g. a square or diamond- like shape. It may possibly also be bent over the shorter transverse edges (21).

As shown in FIGS. 1 and 10, the perforation region (13) may extend in the axial direction as far as one or both longitudinal edges (22) or as far as the end-face screen edge/screen edges (12) formed therefrom on the bent filter screen (4). Alternatively, the perforation region (13) may end at an axial distance in front of one or both longitudinal edges (22) or screen edges (12).

In FIG. 10, the through openings (14) are also shown schematically and enlarged so that they can be better seen. The shape and distribution of the through openings (14) is illustrated by way of example, e.g. in the form of a regular and rectangular matrix in which the through openings (14) are each arranged in a plurality of rectilinear rows and columns. Alternatively, an arrangement of adjacent rows of through openings (14) each positioned with a gap is possible. Furthermore, there may also be any other arrangements and distributions of through openings (14) in the perforation region (13).

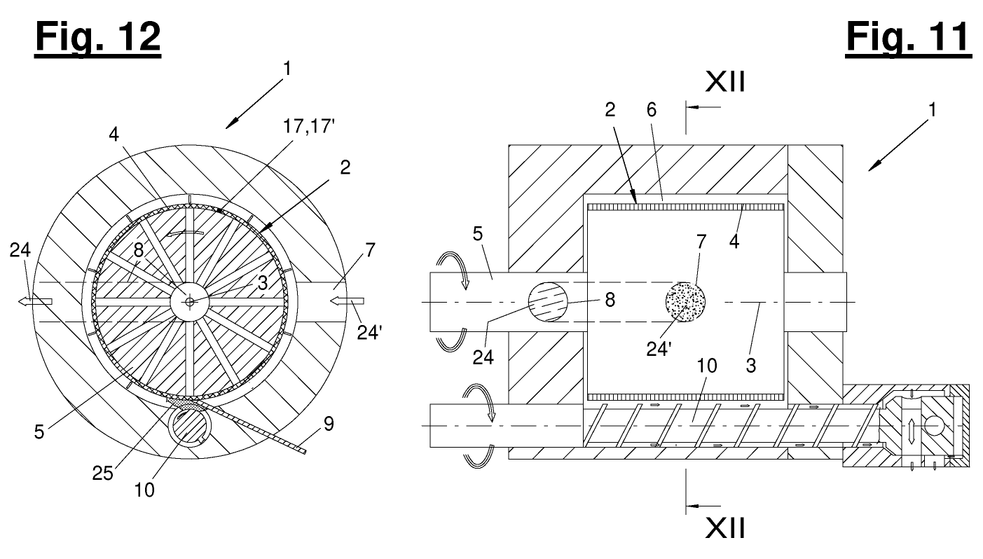

FIGS. 11 and 12 show a filter device (1) with a tubular filter (2) and a filter screen (4) arranged there along with a filter axis (3), a stripper (9) and a discharge apparatus (10). The filter screen (4) which is present individually or in multiple form is arranged, for example, on the outer circumference of a cylindrical filter carrier (5). The filter carrier (5) may have the shape which is shown in the cross section of FIG. 12 and is permeable for the liquid to be filtered, in particular a polymer melt (24,24'). The filter carrier (5) is equipped, for example, as a hollow body, with a plurality of radial bores extending as far as the outer filter screen (4) and opening at a central bore.

IThe filter device (1) comprises, for example, a housing in which is formed a filter chamber (6) at which an inlet (7) for the raw, particle-containing liquid to be filtered, in particular a polymer melt (24'), opens, for example, circumferentially. The filter carrier (5) and the filter screen (4) are arranged in the filter chamber (6). The supplied raw, particle-containing liquid, in particular a polymer melt (24'), flows through the filter screen (4) and its perforation region (13) with the through openings (14), with the particles being filtered out and deposited as filter residues (25) on the filter screen (4). The filtered liquid, in particular a polymer melt (24), is then discharged from the filter screen (4).

The filter carrier (5) is configured, for example, as a rotatable filter shaft, which can be rotationally driven, preferably in a controllable manner, by a drive, not illustrated. An outlet (8) for the filtered liquid, in particular a polymer melt (24), can be led out of the interior of the hollow, circular-cylindrical filter screen (4) and the filter carrier (5). It can be guided outwards, for example, via the shaft extension of the filter shaft.

In the illustration shown, the raw liquid to be filtered, in particular a polymer melt (24'), flows through the filter screen (4) from the outside to the inside. Alternatively, a reverse arrangement is possible in which the flow passes through the screen filter (4) from the inside to the outside, with the inlet (7) extending into the hollow interior of the filter screen (4) and the filter carrier (5) and the outlet (8) on the filter housing being guided outwards. FIG. 1 also illustrates the possibility of closing the filter housing and the filter chamber (6), which is formed therein, on the end face by a removable cover. As a result, the filter screen (4) may be exchanged when required.

In the embodiment shown, the stripper (9), which is, for example, of blade-like configuration, acts on the outer circumference of the filter screen (4) and, during a rotation of the filter, scrapes off the filter residues (25) adhering there. For example, the stripper (9) is stationary. It may be aligned with its active side, in particular the stripper blade, axially and parallel to the filter axis (3). A preferably controllable discharge apparatus (10) is arranged in the region of the stripper (9), the discharge apparatus continuously or intermittently discharging the filter residues (25) which have been scraped off and collected on the stripper (9). The discharge device (10) comprises, for example, a screw-like conveyor shaft which extends parallel to the filter axis and axis of rotation (3) and, by rotation, conveys away the filter residues (25) axially. It can open at the screw end in a discharge chamber in which a metered transverse discharge can take place via a radial receiving channel and a plunger, which is arranged there and is movable in an oscillating manner, in the shaft journal. The stripper (9) and the discharge apparatus (10) can be configured, for example, in accordance with WO 2022/135855 A1.

Modifications of the embodiment shown and described are possible in various ways.

The filter screen (4), tubular filter (2) and filter device (1) and also the screen blank (19) shown in the figures may be modified in the manner specified in the introductory part of the description. The features of these exemplary embodiments and modifications may also be interchanged within the scope of the claims.

While specific embodiments of the invention have been shown and described in detail to illustrate the application of the principles of the invention, it will be understood that the invention may be embodied otherwise without departing from such principles.

### Reference characters

1 Filter device

2 Filter, tubular filter

3 Filter axis

4 Filter screen

5 Filter carrier, filter shaft

6 Filter chamber

7 Inlet

8 Outlet

9 Stripper

10 Discharge apparatus

11 Screen wall

12 Screen edge

13 Perforation region

14 Through opening

15 Region edge of the perforation region

16 Profile geometry

16' Protrusion

16" Indentation

17 Connecting means, weld seam

17' Connecting point, joining point

18 Spacer region

19 Screen blank

20 Blank edge

21 Transverse edge

22 Longitudinal edge

23 Metal sheet

24 Liquid, polymer melt filtered

24' Liquid, polymer melt raw

25 Filter residue

a1 Distance

a2 Distance

t Profile depth

What is claimed is:

1. A filter screen for a tubular filter configured to filter liquids, the filter screen being bent from a flat screen blank to form a tubular filter screen with a filter axis, the filter screen
comprising:a screen wall with a screen wall circumference with a perforation region with densely packed, fine through openings;a connecting means, which is aligned with an axial direction component, wherein the perforation region has, at each of two circumferential direction ends, a region edge, wherein the
two circumferential direction ends extend with an axial direction component, wherein the region edges each end adjacent to the connecting means and spaced at a distance therefrom so as to form a spacer region, wherein at least one of the region edges has an axial profile having a profile geometry with varying edge distances from the adjacent connecting means, and wherein the profile geometry, as viewed in the circumferential direction, has a profile depth which is a multiple of diameters of the through openings.

2. The filter screen according to claim 1, wherein the profile geometry has at least one protrusion pointing towards the connecting means and/or at least one indentation pointing away from the connecting means.

3. The filter screen according to claim 2, wherein in the protrusion pointing towards the connecting means, a plurality of through openings are arranged successively and next to one another in the circumferential direction.

4. The filter screen according to claim 1, wherein the profile geometry has a waveform with a plurality of protrusions pointing towards the connecting means and a plurality of indentations.

5. The filter screen according to claim 4, wherein the profile geometry has a uniform, meandering waveform having rounded and/or angular protrusions and/or indentations.

6. The filter screen according to claim 4, wherein the spacer region between the region edge and the connecting means is solid.

7. The filter screen according to claim 1, wherein the screen wall has a thickness of between 1.0 mm and 2.0 mm, and/or the diameters of the through openings are each between 30 µm and 1500 µm.

8. The filter screen according to claim 1, wherein the connecting means has a straight and
axially aligned linear shape and/or the connecting means is configured as a weld seam.

9. The filter screen according to claim 1, wherein the tubular filter screen has a hollow circular-cylindrical shape and/or the flat screen blank comprises a flat, flexurally elastic metal sheet.

10. The filter screen according to claim 1, wherein the through openings in the screen wall are formed by means of radiation technology.

11. The filter screen according to claim 1, wherein rectilinear blank edges of the bent screen blank are butt-jointed at the connecting means in the circumferential direction.

12. The filter screen according to claim 1, wherein the screen wall is formed by the screen blank, wherein the screen blank is a flat and flexurally elastic rectangular screen blank having a perforation area with the through-openings and area edges, wherein the area edges each end at a distance in front of an adjacent blank edge.

13. A tubular filter for filtering liquids, the tubular filter comprising:
a filter screen, which is bent from a flat screen blank to a tubular shape, the filter screen having a filter axis, the filter screen comprising a screen wall with a circumference of the screen wall having a perforation region with densely packed, fine through openings; and
a connecting means having an axial direction component aligned with a tubular filter axial direction, wherein the perforation region has two circumferential ends, each with a region
edge with an axial direction component aligned with a tubular filter axial direction, the region edges each end adjacent to the connecting means and spaced at a distance therefrom so as to form a spacer region, wherein at least one of the region edges has an axial profile having a profile geometry with varying edge distances from the adjacent connecting means, and wherein
the profile geometry, as viewed in the circumferential direction, has a profile depth which is a multiple of diameters of the through openings.

14. The tubular filter according to claim 13, further comprising a filter carrier, wherein the filter screen is arranged circumferentially on the filter carrier.

15. The tubular filter according to claim 14, wherein the filter carrier is configured as a rotatable filter shaft.

16. The tubular filter according to claim 13, wherein the tubular filter is configured to
filter polymer melts.

17. A filter device for filtering liquids, the filter device comprising a tubular filter, the tubular filter comprising:
a filter screen, which is bent from a flat screen blank to a tubular shape, the filter screen
having a filter axis, the filter screen comprising a screen wall with a circumference of the screen wall having a perforation region with densely packed, fine through openings; and
a connecting means having an axial direction component aligned with a tubular filter axial direction, wherein the perforation region has two circumferential ends, each with a region edge with an axial direction component aligned with a tubular filter axial direction, the region edges each end adjacent to the connecting means and spaced at a distance therefrom so as to
form a spacer region, wherein at least one of the region edges has an axial profile having a profile geometry with varying edge distances from the adjacent connecting means, and wherein the profile geometry, as viewed in the circumferential direction, has a profile depth which is a multiple of diameters of the through openings.

18. The filter device according to claim 17, further comprising:
a stripper configured to strip filter residues, the stripper being arranged on an outside or inside of the circumference of the tubular filter screen; and
a discharge apparatus configured to interact with the stripper for a discharge of stripped filter residues.

19. The filter device according to claim 17, further comprising a filter chamber with an inlet and an outlet for the liquid to be filtered, the filter screen being arranged in the filter chamber stationarily or movably and rotationally driven and being connected to the inlet and the outlet.

20. The filter device according to claim 17, wherein the filter device is configured to
filter polymer melts.
